(19) United States
(12) Patent Application Publication
(10) Pub. No.: US 2009/0292691 A1
(43) Pub. Date: Nov. 26, 2009

(54) System and Method for Building Multi-Concept Network Based on User's Web Usage Data

(75) Inventors: Jeehyung Lee, Seoul (KR); Taebok Yoon, Suwon-si (KR); Jaekwang Kim, Suwon-si (KR); Donghoon Lee, Suwon-si (KR); Kwangho Yoon, Suwon-si (KR)

Correspondence Address: Ballard Spahr LLP, SUITE 1000, 999 PEACHTREE STREET, ATLANTA, GA, 30309-3915, US

(73) Assignee: SUNGKYUNKWAN UNIVERSITY Foundation For Corporate Collaboration, Suwon-si (KR)

(21) Appl. No.: 12/388,915

(22) Filed: Feb. 19, 2009

(30) Foreign Application Priority Data
May 21, 2008 (KR) 10-2008-0046864

(51) Int. Cl. G06F 17/30

(52) U.S. Cl. 707/5; 707/E17.108

(57) ABSTRACT

A system and method for building a multi-concept network based on web usage data that collect keywords used in a search site utilized by a plurality of users and web page information and build the multi-concept network for the keywords are provided. The method includes (a) collecting the keywords input by the users for searches in the site and the information on web pages read according to keyword search results; (b) for each keyword, selecting read web pages for each user; (c) for each keyword, setting each selected web page as one node, grouping the web page nodes for each user, connecting the web page nodes in a row, and arranging the web page nodes around the keyword; and (d) obtaining a similarity between two groups of the web page nodes arranged around the keyword, and integrating the two groups to form one group connected in a row when the similarity is above a predetermined standard value.

With the system and method, web page usage data for each user for a user's interest keyword is collected to build a web page connection network. Thus, a web page connection network based on information on a variety of tendencies can be provided.

### CROSS-REFERENCE TO RELATED APPLICATION

This application claims priority to and the benefit of Korean Patent Application No. 10-2008-0046864, filed on May 21, 2008, the disclosure of which is incorporated herein by reference in its entirety.

### BACKGROUND

1. Field of the Invention

The present invention relates to a system and method for building a multi-concept network based on web usage data that collect keywords used in a search site utilized by many users and web page information to produce a multi-concept network for the keywords.

The present invention also relates to a system and method for building a multi-concept network based on web usage data that groups read web pages for each user for a corresponding keyword and centers the web pages on the keyword.

2. Discussion of Related Art

In general, users spend a great deal of time and effort to obtain desired information from web pages. But for all their time and effort, satisfactory results are not easily obtained. The reason for this is that the rapid development of IT technology has been accompanied by geometrical increase in web information and it is difficult to obtain desired information from a large amount of data.

Accordingly, a variety of research is currently seeking a solution to the aforementioned problem. To more intelligently service information desired by users on the web environment, the research includes research into understanding web contents and structure, and research into analyzing web usage data of users to measure web page effectiveness. In particular, the latter is actively underway based on a data mining scheme. Such research is very useful as basic technology for web page recommendation.

Research into web page recommendation for providing proper information for users' interest keywords includes research into indicating users' activities on the web as a sequence and comparing and analyzing similarities between users [References 1 and 2], research into web page evaluation using user activity information to analyze web page usage data of users [Reference 3], research into discovering only necessary information among existing user path information based on web page path information of users, building a database (DB), and providing service, and research into investigating and analyzing associated exploration activities of not just one but several web pages [Reference 4].

### REFERENCES

[Reference 1] Chang H. Joh, Theo A. Arentze, Harry J. P. Timmermans, “A Position-Sensitive Sequence Alignment Method Illustrated for Space-Time Activity-Diary Data,” Environment and Planning A 2001, vol. 33, pages 313˜338, 2001.
[Reference 2] Birgit Hay, Geert Wets, Koen Vanhoof, “Clustering Navigation Patterns on a Website Using a Sequence Alignment Method,” Proc. Intelligent Techniques for Web Personalization: 17th Int. Joint Conf. Artificial Intelligence, 2000.
[Reference 3] M. M. Sufyan Beg, Nesar Ahmad, “Web Search Enhancement by Mining User Actions,” Information Sciences, vol. 177, pp. 5203-5218, 2007.
[Reference 4] Ryen W. White, Steven M. Drucker, “Investigating Behavioral Variability in Web Search,” The International World Wide Web Conference 2007.

As described above, in the conventional research, log information for web page usage is mined to discover a pattern and model web usage data. That is, a method for evaluating a web page using conventional web usage mining includes analyzing web page usage activity of many users and providing a collective, standardized result.

However, by building a model without considering various tendencies of many users, limited service is provided. Web page usage data of many users includes information on a variety of tendencies. Thus, there is a need for an analysis method capable of reflecting information on a variety of tendencies.

### SUMMARY OF THE INVENTION

The present invention is directed to a system and method for building a multi-concept network based on web usage data that collects keywords used in a search site utilized by many users and web page information and builds the multi-concept network for the keywords.

The present invention is also directed to a system and method for building a multi-concept network based on web usage data by grouping read web pages for each user for a keyword and centering the web pages on the keyword.

According to an aspect of the present invention, there is provided a method for building a multi-concept network based on web usage data that collects keywords used in a search site utilized by a plurality of users and web page information and builds the multi-concept network for a specific keyword, the method including: (a) collecting the keywords input by the users for searches in the site and the information on web pages read according to keyword search results; (b) for each keyword, selecting read web pages for each user; (c) for each keyword, setting each selected web page as one node, grouping the web page nodes for each user, connecting the web page nodes in a row, and arranging the web page nodes around the keyword; and (d) obtaining a similarity between two groups of the web page nodes arranged around the keyword, and integrating the two groups to form one group connected in a row when the similarity is above a predetermined standard value.

In step (a), the collected web page information may include web page URLs, and the collected web page information may include, as web page evaluation factors, at least one of web page use start time and end time, download rate, edit command use rate, addition to Favorites rate, and web page contents size.

Step (b) may include: obtaining a weight of a web page by weighting evaluation factors of the web page information and summing the weighted factors, and selecting a web page only if its weight meets a predetermined standard.

Step (b) may include: setting a PageWeight value as the web page weight, the PageWeight value being obtained by Expression 1 using evaluation factors Attributeᵢ (i=1, 2, . . . , n) of the web page information, and selecting only web pages whose weight exceeds a predetermined standard value:

$${PageWeight}_{j} = 1 - ( \frac{1}{{\sum }_{i = 0}^{n} ( {C}_{i} \cdot {Attribute}_{i} )} ) \qquad Expression 1$$

Step (c) may include: when the group includes overlapping web pages, integrating the overlapping web pages into a first read web page.

Step (d) may include: when the two groups are integrated into one group, integrating overlapping web pages between the two groups into a first read web page.

When the web pages are integrated, the weight of the resulting web page may be determined as the sum of the weights of the integrated web pages.

Step (d) may include: obtaining the similarity between the two groups by multiplying the number of overlapping web pages and the number of non-overlapping web pages by weights.

Step (d) may include: obtaining the similarity between the two groups using Equation 2:

Sim(X,Y)=ω_{S}S×ωᵤU Expression 2

where S denotes the number of web pages included in both of the two groups, U denotes the number of web pages not included in both of the two groups, Ws denotes weights of the web pages included in both of the two groups, and Wu denotes weights of the web pages not included in both of the two groups.

According to another aspect of the present invention, there is provided a computer-readable recording medium having a method recorded thereon for building a multi-concept network based on web usage data.

According to still another aspect of the present invention, there is provided a system for building a multi-concept network based on web usage data that collects keywords used in a search site utilized by a plurality of users and web page information and builds the multi-concept network for a specific keyword, the method comprising: a web usage collector for collecting the keywords input by the users for searches in the site and the information on web pages read according to keyword search results; a page selector for, for each keyword, selecting read web pages for each user; a connection network builder for, for each keyword, setting each selected web page as one node, grouping the web page nodes for each user, connecting the web page nodes in a row, and arranging the web page nodes around the keyword; and a connection network modifier for obtaining a similarity between groups of the web page nodes arranged around the keyword, and integrating the two groups to form one group connected in a row when the similarity is above a predetermined standard value.

In the web usage collector, the collected web page information may include web page URLs, and the collected web page information may include, as web page evaluation factors, at least one of web page use start time and end time, download rate, edit command use rate, addition to Favorites rate, and web page contents size.

The page selector may obtain a weight of a web page by weighting evaluation factors of the web page information and summing the weighted factors, and select the web page only if the web page weight meets a predetermined standard.

The page selector may set a PageWeight value as the web page weight, the PageWeight value being obtained by Expression 3 using evaluation factors Attributeᵢ (i=1, 2, . . . , n) of the web page information, and select only web pages whose weight exceeds a predetermined standard value:

$${PageWeight}_{j} = 1 - ( \frac{1}{{\sum }_{i = 0}^{n} ( {C}_{i} \cdot {Attribute}_{i} )} ) \qquad Expression 3$$

When the group includes overlapping web pages, the connection network builder may integrate the overlapping web pages into a first read web page.

When the two groups are integrated into one group, the connection network modifier may integrate overlapping web pages between the two groups into a first read web page.

When the web pages are integrated, the weight of the resulting web page may be determined as the sum of the weights of the integrated web pages.

The connection network modifier may obtain the similarity between the two groups by multiplying the number of overlapping web pages and the number of non-overlapping web pages by weights.

The connection network modifier may obtain the similarity between the two groups using Expression 4:

Sim(X,Y)=ω_{S}S×ωᵤU Expression 4

where S denotes the number of web pages included in both of the two groups, U denotes the number of web pages not included in both of the two groups, Ws denotes weights of the web pages included in both of the two groups, and Wu denotes weights of the web pages not included in both of the two groups.

According to still another aspect of the present invention, there is provided a method for recommending a web page to a user who searches for a web page in a search site, using a multi-concept network built by the method described above, the method comprising: (e) receiving and storing the multi-concept network consisting of a plurality of keywords and web page nodes grouped and arranged around the keywords; (f) capturing a keyword input by the user in the search site and information on web pages read according to keyword search results; (g) selecting the web pages read using the keyword; (h) determining whether there is an association between the selected web pages and groups of web page nodes arranged around the same keyword in the multi-concept network; and (i) when it is determined in step (h) that there is an association, recommending web pages belonging to the web page node group to the user.

Step (g) may include: obtaining a weight of a web page by weighting evaluation factors of the web page information and summing the weighted factors, and selecting a web page only if its weight meets a predetermined standard.

Step (h) may include: obtaining an association degree between the read web pages and the web page node groups by multiplying the number of overlapping web pages and the number of non-overlapping web pages by weights; and determining that there is an association between the read web pages and the web page node groups when the association degree exceeds a predetermined standard value.

According to yet another aspect of the present invention, there is provided a system for recommending a web page to a user who searches for a web page in a search site, using a multi-concept network built by the building system described above, the system comprising: a connection network storage unit for receiving and storing a multi-concept network consisting of a plurality of keywords and web page nodes grouped and arranged around the keywords; a web usage capturing unit for capturing a keyword input by the user in the search site and information on web pages read according to keyword search results; an association determiner for determining whether there is an association between the web pages read using the keyword and groups of web page nodes arranged around the same keyword in the multi-concept network; and a page recommender for recommending web pages belonging to the web page node group to the user when it is determined by the association determiner that there is an association.

The association determiner may obtain an association degree between the read web pages and the web page node groups by multiplying the number of overlapping web pages and the number of non-overlapping web pages by weights, and determine that there is an association between the read web pages and the web page node groups when the association degree exceeds a predetermined standard value.

As described above, with the system and method for building a multi-concept network based on web usage data according to the present invention, web page usage data are collected for each user for a user's interest keyword to build a web page connection network. Thus, it is possible to provide a web page connection network based on information on a variety of tendencies.

Furthermore, with the system and method for building a multi-concept network based on web usage data according to the present invention, user tendencies are guessed from several web pages read by the user based on interest keywords so that web pages read by other users having the same tendencies can be recommended.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of a system according to the present invention;

FIG. 2 is a flowchart illustrating a typical procedure of searching for a web page containing desired information using a keyword in a search site;

FIG. 3 illustrates an example of a multi-concept network according to the present invention;

FIG. 4 is a flowchart illustrating a method for building a multi-concept network based on web usage data according to an exemplary embodiment of the present invention;

FIG. 5 illustrates an example in which read pages are selected for each user according to an exemplary embodiment of the present invention;

FIG. 6 illustrates an example in which selected web pages are arranged around a keyword according to an exemplary embodiment of the present invention;

FIG. 7 illustrates an example in which web page groups are integrated according to a similarity between the web page groups arranged around a keyword according to an exemplary embodiment of the present invention.

FIG. 8 illustrates an example of a multi-concept network completed according to an exemplary embodiment of the present invention;

FIG. 9 is a flowchart illustrating a method for recommending a web page using a multi-concept network according to an exemplary embodiment of the present invention;

FIG. 10 is a block diagram of a system for building a multi-concept network based on web usage data according to an exemplary embodiment of the present invention;

FIG. 11 is a block diagram of a system for recommending a web page using a multi-concept network according to an exemplary embodiment of the present invention;

FIG. 12 illustrates keywords used for an experiment for building a web usage data-based multi-concept network according to an exemplary embodiment of the present invention; and

FIG. 13 illustrates a resultant multi-concept network built according to the experiment in FIG. 12.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Further, like components will be denoted by like reference numerals and described only once.

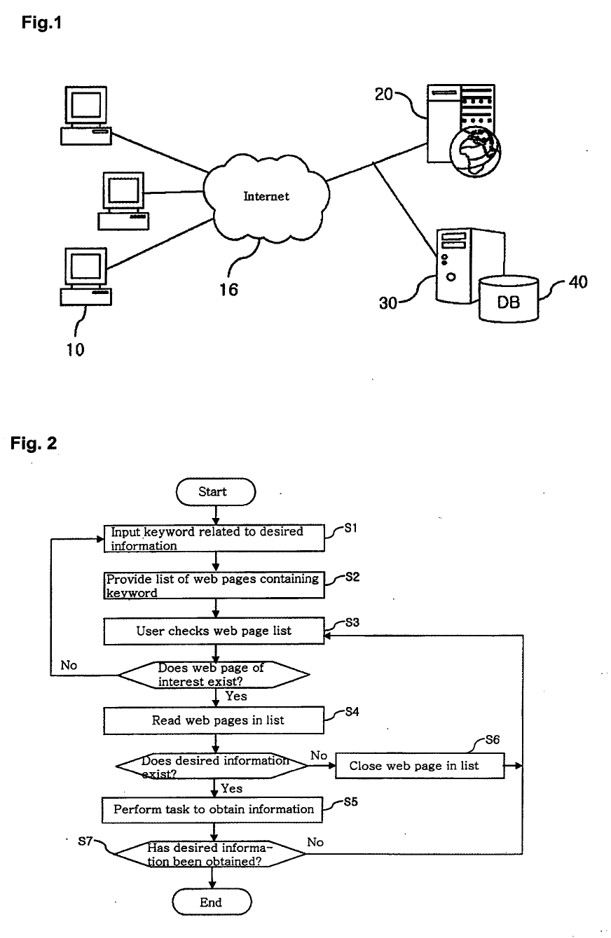

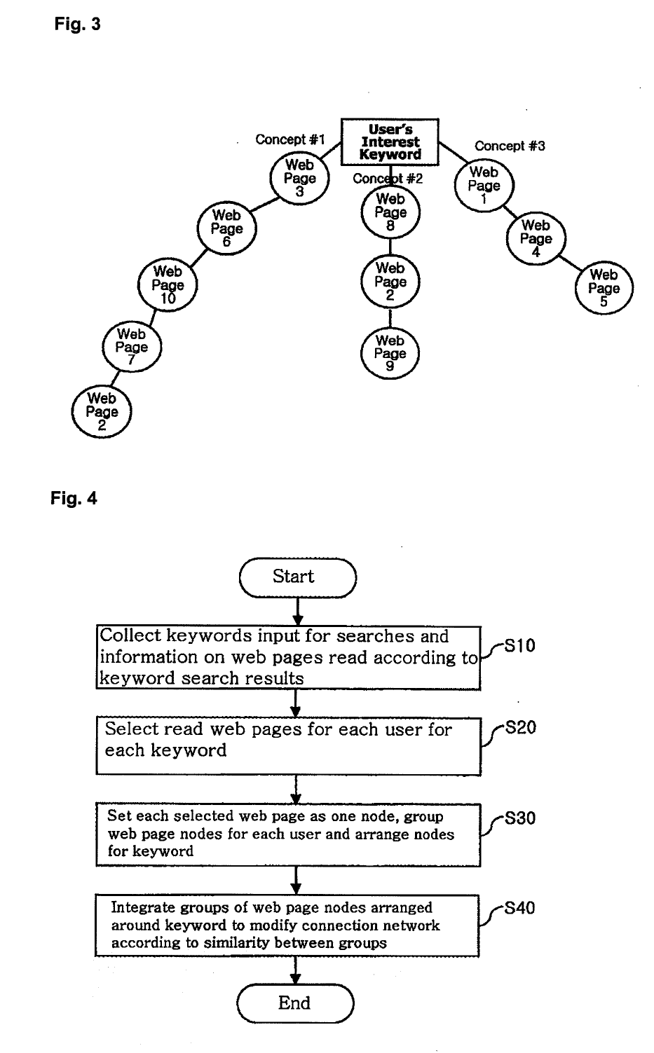

A system according to the present invention and the concept of a multi-concept network to be built using the system will first be described with reference to FIGS. 1 to 3. FIG. 1 is a block diagram of a system according to the present invention. FIG. 2 is a flowchart illustrating a typical procedure of searching for a web page containing desired information using a keyword in a search site, and FIG. 3 illustrates an example of a multi-concept network according to the present invention.

Referring to FIG. 1, a user 10 first accesses a search site 20 in order to obtain information on the Internet. The user 10 then inputs a keyword related to information to discover in the search site 20, and searches for web pages.

The user 10 uses a user terminal, such as a personal computer (PC), a notebook computer, a portable telephone, or a personal digital assistant (PDA), to access the search site 20. In FIG. 1, reference numeral 10 is used to indicate either the user terminal or the user. When the reference numeral indicates the user, it means that the user 10 performs any task using the user terminal 10. The user terminal 10 may be any device capable of accessing the search site 20 to search for information.

The search site 20 is a typical web server for providing web page search service. In particular, the search site 20 is a web server for searching for web pages associated with an input keyword. Meanwhile, the search site 20 provides search service to a plurality of users 10 who access the search site.

The user terminal 10 and the search site 20 are connected to each other over a network 16 such as the Internet. The network 16 may be any of networks including wired Internet, wireless Internet, etc. that enable users to access the search site 20 and receive the search service from the search site 20.

A system 40 for building a multi-concept network according to the present invention collects or captures information on web pages that the user 10 searches for and reads using a keyword in the search site 20. The system 40 includes a module disposed in the search site 20 for collecting or capturing the information, or a device disposed before the search site 20 for collecting or capturing information transmitted to or received from the user terminal 10. Since the system 40 capturing or collecting the information serviced to the user 10 is well known in the art, a detailed description of it will be omitted.

A search procedure performed by the user 10 to discover desired information in the search site 20 will now be described in greater detail with reference to FIG. 2.

As shown in FIG. 2, the user 10 first accesses the search site 20 and inputs a keyword related to desired information to request the search site 20 to perform search (S1). The search site 20 searches for web pages containing the keyword and provides a list of the web pages to the user 10 (S2). Of course, the search site 20 has search policies for more effectively providing search results, such as by preferentially showing web pages containing the keyword greater numbers of times. However, the search results provided by the search site 20 do not always immediately present correct web pages including the information desired by the user.

Accordingly, the user 10 discovers web pages containing the desired information by checking the web pages in the provided list one by one (S3). Specifically, the user 10 discovers web pages that are likely to contain the desired information from the list and then reads the web pages (S4). However, all the read web pages will not contain the desired information. Accordingly, when the read web page does not contain the desired information, the user 10 immediately closes the web page and reads other web pages (S6).

When the read page contains the desired information, the user 10 will stay on the web page for a long time to read the web page in detail. The user 10 will perform a task for storing information about the web page, such as by copying the web page or adding it to Favorites (S5).

After discovering the desired information, the user 10 will terminate the search (S7). However, not discovering the desired information, the user 10 will check the web pages in the list (S3). Not discovering the desired information from the web pages in the searched list using the keyword, the user 10 will input another keyword to update the web page list.

The concept of a multi-concept network built by the system 40 for building a multi-concept network according to the present invention will now be described with reference to FIG. 3.

Information collected by the system 40 in the search site 20 includes a keyword input by the user 10 to discover the desired information and information on read web pages searched for using the keyword.

Meanwhile, there are many cases where the user 10 uses the same keyword to discover different desired information. For example, when users search for desired information on the web site using the keyword, “soccer,” some users may desire information on an ongoing soccer match, and some may desire information on soccer players. Others may be searching for soccer goods to purchase. As such, the users may desire different information using the same keyword.

That is, the users have different tendencies for one keyword. A model reflecting such tendencies is called a multi-concept network (MC-Net). This network reflects users having different thoughts about the keyword due to different background knowledge or values.

In other words, the system 40 for building a multi-concept network according to the present invention builds the multi-concept network (MC-Net) by collecting log information for web searches using user keywords and web usage, and analyzing the log information. The multi-concept network differently expresses connections of meaningful web pages based on a user's interest keyword depending on the user's tendencies. The keyword involves information on a variety of tendencies and the multi-concept network has different web page connections depending on the tendency information. That is, the multi-concept network is a keyword-based web page connection network built by analyzing the web page usage data of the user.

In the above example, the soccer match, the soccer players, or the soccer goods are searched for using the keyword “soccer.” As described above, a keyword tendency network shown in FIG. 3 may be built based on web usage data of many users. FIG. 3 illustrates an example of a multi-concept network (MC-Net) built by analyzing a user's interest keyword. Ten meaningful web pages 1 to 10 were collected based on the user's interest keyword and classified into three concepts #1 to #3.

Since such a multi-concept network includes information on a variety of tendencies for the keyword, it can represent different thoughts about the keyword due to different background knowledge or values among the users. Accordingly, the network may be usefully applied to web search recommendation, keyword-based advertisement, inter-word meaning recognition, etc.

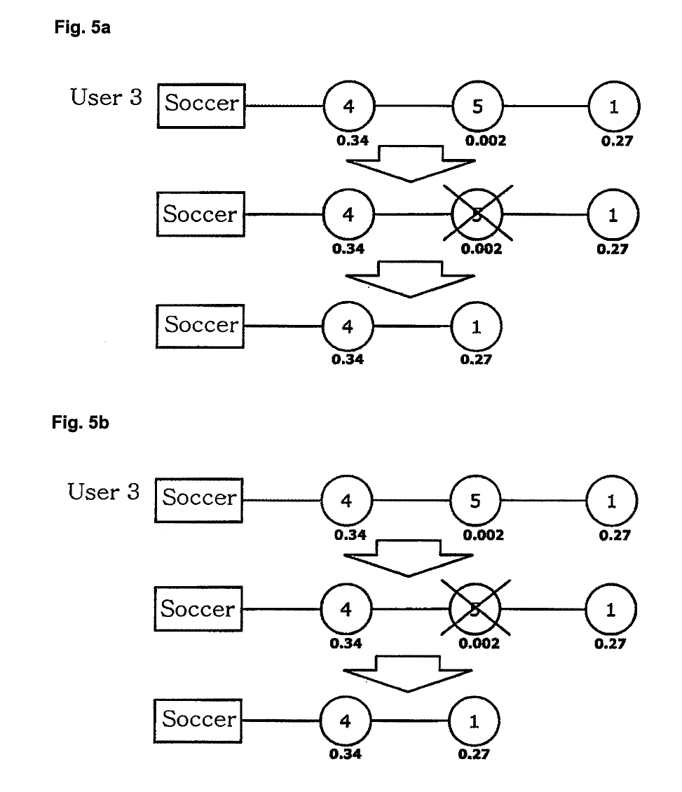

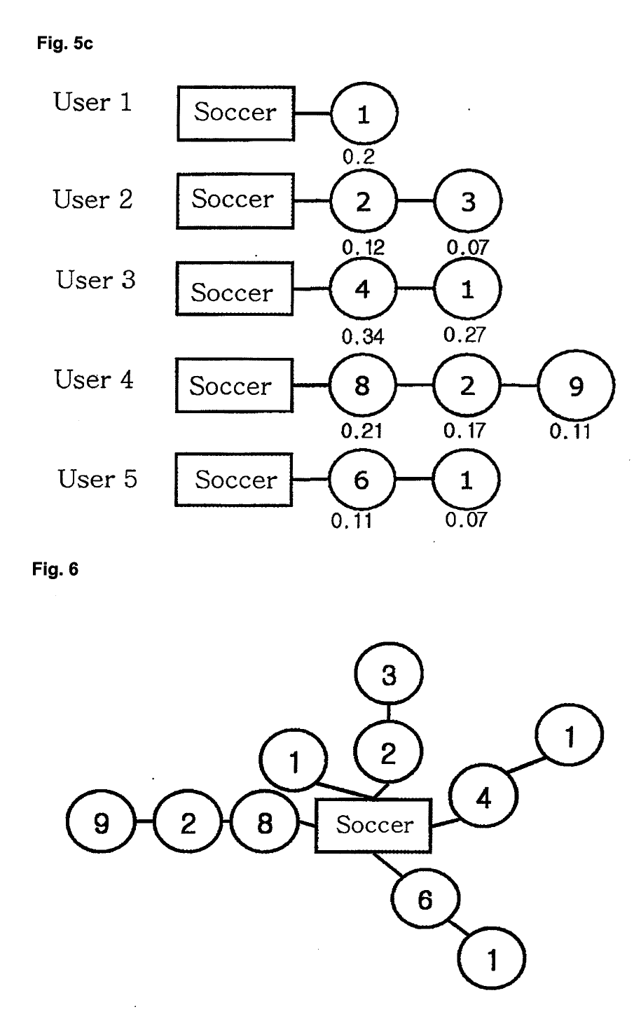

A method for building a multi-concept network based on web usage data according to an exemplary embodiment of the present invention will now be described with reference to FIGS. 4 to 8. FIG. 4 is a flowchart illustrating the method for building a multi-concept network based on web usage data according to an exemplary embodiment of the present invention. FIGS. 5 to 8 illustrate steps of the method shown in FIG. 4.

As shown in FIG. 4, the method for building a multi-concept network based on web usage data according to an exemplary embodiment of the present invention includes: (a) collecting keywords input by the user 10 for search in the search site 20, and information on web pages read according to keyword search results (S10); (b) selecting the read web pages for each user for each keyword (S20); (c) for each keyword, setting each selected web page as one node, grouping the web page nodes for each user and connecting the nodes in a row to arrange the nodes around the keyword (S30); and (d) obtaining a similarity between groups of web page nodes arranged around the keyword, and integrating the groups to form one group connected in a row when the similarity is above a predetermined standard value (S40).

In step (a), the keyword input by the user 10 for search in the search site 20 and information on web pages read according to keyword search results are collected (S10). As described above, the users 10 access a web page through any of a variety of search sites 20 including Google, Yahoo, Naver, etc. in order to obtain desired information in the web environment. The user 10 searches for and reads web pages by inputting a keyword. The keyword input and the information read by the user 10 are collected.

As shown in FIG. 5a, the collected information consists of web pages read using one keyword “WorldCup.” In particular, web pages read by one user are connected to form a connection network. In FIG. 5, web pages read by the respective users, i.e., user 1 to user 5, and connected into one group are shown. The web pages 1 to 9 are shown. For example, user 2 reads web pages 2 and 3 using the keyword “soccer” and user 4 reads web pages 8, 2 and 9.

The respective users use the same keyword “soccer,” but have different search purposes, i.e., desired information. That is, the web pages for the keyword “soccer” input by the respective users have different tendencies.

Meanwhile, in step (a), the collected web page information includes web page URLs. The collected web page information includes, as web page evaluation factors, at least one of web page use start time and end time, download rate, edit command use rate, addition to Favorites rate, and web page contents size.

When the user 10 performs a search using any keyword and reads a specific web page meaningfully, information on the web page may be utilized as useful information for web searches recommendation. A user's interest keyword, a user ID, and information on activity of the user 10 on the read web page are elements for measuring how useful the web page was to the user 10. Collectable activity information of the user 10 who used the web page includes an user ID, a web page URL used using the interest keyword, page use start time and end time, download rate, a Copy & Paste command (Ctrl+C) use rate, addition to Favorites rate, web page contents size, etc.

In step (b), the read web pages are selected for each user for each keyword (S20).

Prior to analysis based on log information for usage of collected web pages using the user's interest keyword, a preprocessing task is necessary. When the web page is used for too short of a time, it may be determined not to include content desired by the user. In this case, such a web page must be excluded from the analysis. On the web log collecting process, erroneous data caused by a system error must be excluded from the analysis.

For example, the user 10 checks the list of the searched web pages and reads a web page that is likely to include desired information in FIG. 2. However, the read web page may not include the desired information. Accordingly, such read web page must be excluded. That is, only web pages that were actually useful to the user 10 must be included.

For quantitative representation of how a web page is useful to a user, a web page scoring method is used. Here, it is important how much relationships between respective elements used for scoring affect each other. In general, the score is determined to be 0 to 1. Importance of the respective elements is determined by weights. In this disclosure, the respective elements are considered to have the same meanings for weighting.

In step (b), web pages are selected using values obtained by weighting evaluation factors for the web page information and summing weighted factors. Specifically, in step (b), only web pages having PageWeight values above a predetermined standard value are selected, in which the PageWeight values are obtained by Expression 1 using evaluation factors Attributeᵢ (i=1, 2, . . . , n) of the web page information:

$${PageWeight}_{j} = 1 - ( \frac{1}{{\sum }_{i = 0}^{n} ( {C}_{i} \cdot {Attribute}_{i} )} ) \qquad Expression 1$$

PageWeightⱼ denotes a page weight value of a j-th web page among several pages read by the user using any keyword, n denotes the number of web page evaluation factors (user web activities, such as time, Favorites, etc.). Attributes denotes an i-th element and Cᵢ denotes a weight (constant) of the i-th element.

PageWeightⱼ have a value between 0 and 1. As the PageWeightⱼ value approaches 1, it indicates that the web page is meaningfully read by the user.

In the example of FIG. 5b, PageWeightⱼ is obtained from information on web pages read by five users using the keyword “soccer.” In FIG. 5b, figures indicated below web page circles and less than 1 are PageWeightⱼ. When it is assumed that a standard value for selection is 0.01, web page 5 of user 3 has 0.002 less than the reference and web pages 4 and 1 have 0.34 and 0.27 more than the reference. Accordingly, only the web pages 1 and 4 are selected.

Meanwhile, in FIG. 5a, user 4 twice reads web page 8 using the keyword “soccer.” In the first reading, web page 8 is excluded from the selection since PageWeightⱼ is 0.009. On the other hand, in the second reading, the web page 8 is selected since PageWeightⱼ is 0.36. That is, where the user 10 reads one web page several times, the web page is selected if the highest PageWeightⱼ is above the predetermined standard value.

Finally, the web pages are more closely connected to the keyword in order of higher page weight. As shown in the last figure of FIG. 5b, in the case of the user 3 inputting the keyword “soccer,” web page 4 has the highest weight of 0.34 and then web page 1 has a weight of 0.27. Accordingly, web pages are more closely connected to the keyword in order of weight as described above.

Although the page weights of the web pages are used as evaluation factors for filtering meaningless web pages in preprocessing, they may be a measure of how highly the user is interested in the web pages. Accordingly, the page weight value indicates a size of user's interest in each web page or node, and a size of a web page role of best representing the tendency of the web page group. That is, it can be appreciated that the user is highly interested in web pages more closely connected to the keyword.

Through preprocessing, the web pages are arranged around the keyword for each user, as shown in FIG. 5c.

In step (c), each selected web page is set as one node and the web page nodes are grouped for each user and connected in a row, such that the web pages are arranged around the keyword (S30). In particular, in step (c), a first read web page is more closely connected to the keyword. In step (c), when one group includes overlapping (or the same) web pages, the overlapping web pages are integrated into the first read web page.

That is, the web page arrangement for the keyword for each user in FIG. 5c may be represented as an integrated keyword network, as shown in FIG. 6. That is, the keyword is placed at a center of the network, and web pages read and selected by the respective users are connected to the keyword as a group. Accordingly, the respective web pages are arranged around the keyword to form a connection network as shown in FIG. 6.

In the case of the network built as shown in FIG. 6, although the meaningless web pages are eliminated by preprocessing, the network is complex and large as it is built for the respective users. Accordingly, an integration process must be performed on users reading similar web pages through analysis.

In step (d), a similarity between groups of web page nodes arranged around the keyword is obtained, and when the similarity is above a predetermined standard value, the groups are integrated as one group connected in a row (S40). In particular, in step (d), the similarity between two groups is obtained by multiplying the number of overlapping web pages and the number of non-overlapping web pages by weights.

That is, a possible implicit expression between users reading similar web pages, in addition to simply listing web page groups read by the user with reference to the interest keyword, is helpful to understand the built network. Further, if information on n users is collected, the network has n braches (or groups), in which a higher n increases a cost required for network management and computation. Accordingly, it is necessary for groups (or braches or arrangements) having similar tendencies to be integrated into one.

Expression 2 is intended to compare the two groups in order to determine whether they are similar, i.e., to obtain the similarity between the two groups:

Sim(X,Y)=ω_{S}S×ωᵤU Expression 2

S denotes the number of web pages included in both of the two groups, and U denotes the number of web pages not included in both of the two groups. Further, Ws denotes weights of the web pages included in both of the two groups, and Wu denotes weights of the web pages not included in both of the two groups. When the two groups have a similarity above a predetermined standard value, they are integrated and the web page weights are summed to give one weight.

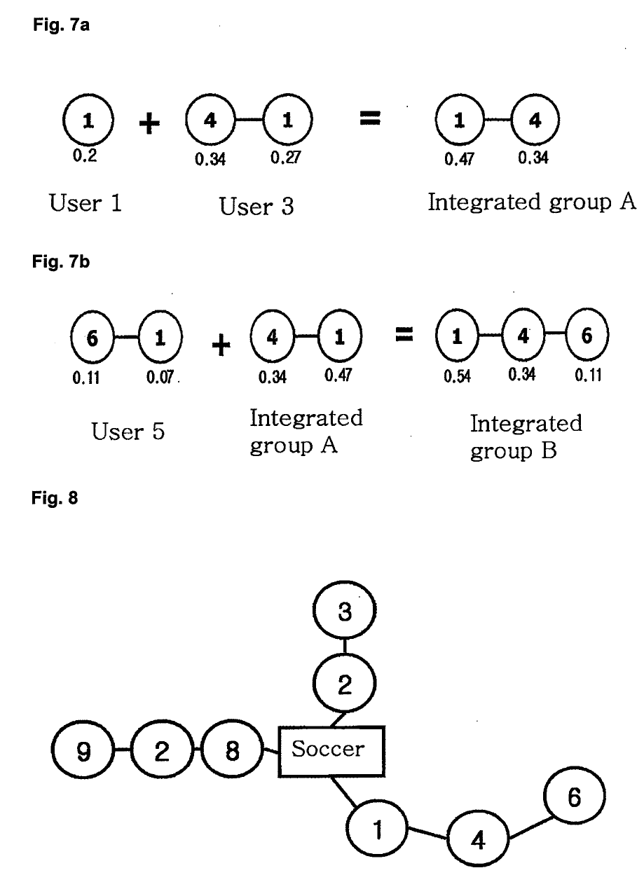

To arrange and integrate the network groups, two user groups are first selected and compared with each other. An example will be described with respect to user 1 to user 5 of FIG. 5c with reference to FIG. 7. User 1 used web page 1, user 3 used web pages 4 and 1, and user 5 used web pages 6 and 1.

For example, it is assumed that the weight is 5 when the two groups are the same and the weight is 1 when the two groups differ. As shown in FIG. 7a, the weight of user 1 and user 3 is 4 (=(1*5)+(1*(−1))). A similarity standard value for integrating the two web page groups is set to 3. Since the similarity between user 1 and user 3 is 3, which is above the standard value, user 1 and user 3 are integrated into group A. In this case, the page weight of the web page 1 becomes 0.47, which is 0.2 of user 1 plus 0.27 of user 3. Accordingly, since in integrated group A, web page 1 has a greater page weight than web page 4, it is connected before web page 4. As shown in FIG. 7b, a similarity between user 5 and integrated group A is obtained. That is, a weight of user 5 and integrated group A is 3(=(1*5)+(2*(−1)). Accordingly, user 5 and integrated group A are integrated into an integrated group B. In this case, the page weight of web page 1 becomes 0.54, which is equal to 0.07 of user 5 plus 0.47 of integrated group A. Integrated group B consists of web pages 1, 4, and 6, which are connected as shown in FIG. 7b according to the page weights.

Meanwhile, although in FIG. 5c, both user 2 and user 4 include web page 2, they are not integrated since the similarity between the two groups, which is 2 (=(1*5)+(3*(−1))), is less than 3.

By analyzing the similarity among the web page groups of FIG. 5c and integrating the groups, a multi-concept network (MC-Net) exhibiting three tendencies for the keyword “soccer” was built as shown in FIG. 8.

As shown in FIG. 8, the built multi-concept network has a network structure that represents web page information for a variety of tendencies, rather than web page information for one tendency, based on the keyword. The multi-concept network includes information for properly coping with user tendencies, rather than selecting a web page having only one meaning for any keyword.

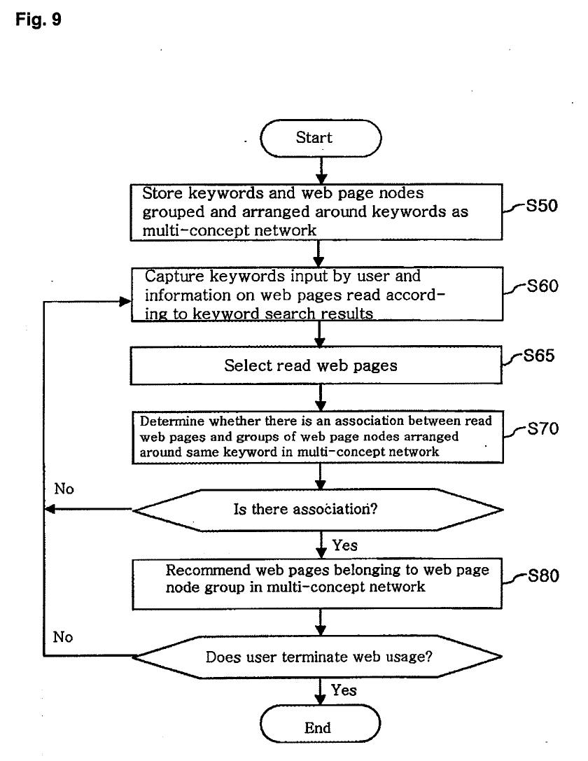

A method for recommending a web page using a multi-concept network according to an exemplary embodiment of the present invention will now be described with reference to FIG. 9. FIG. 9 is a flowchart illustrating the method for recommending a web page.

Referring to FIG. 9, the method for recommending a web page using a multi-concept network includes: (e) receiving and storing a multi-concept network consisting of a plurality of keywords and web page nodes grouped and arranged around the keywords (S50); (f) capturing a keyword input by a user in a search site and information on web pages read according to keyword search results (S60); (g) selecting the web pages read using the keyword (S65); (h) determining whether there is an association between the selected web pages and groups of web page nodes arranged around the same keyword in the multi-concept network (S70); and (i) when it is determined in step (h) that there is an association, recommending web pages belonging to the web page node group to the user (S80).

In step (e), the multi-concept network built by the method for building a multi-concept network is received and stored in advance, so that the multi-concept network can be used (S50).

Information on search activity performed by the user 10 in the search site 20 is then captured. That is, in step (f), a keyword input by the user in the search site and information on web pages read according to keyword search results are captured (S60).

In step (g), the web pages read using the keyword are selected (S65). The selection is performed by the same selection procedure as in step (b) of the above method for building a multi-concept network.

A web page group in the multi-concept network associated with the captured web page information is discovered. That is, in step (h), a determination is made as to whether there is an association between the selected web pages and groups of web page nodes arranged around the same keyword in the multi-concept network (S70). In particular, in step (h), an association degree between the read web pages and the web page node groups is obtained by multiplying the number of overlapping web pages and the number of non-overlapping web pages by weights. When the association degree exceeds a predetermined standard value, it is determined that there is an association between the read web pages and the web page node groups.

That is, the association degree between the pages read by the user 10 and the stored web page groups in the multi-concept network is obtained using the same method used to obtain the similarity between the web page groups in the multi-concept network. Further, an association standard is determined, like the similarity standard.

Since the similarity is to determine whether two web pages have similar tendencies, web pages read by the user 10 having the tendencies are determined to have the association.

In other exemplary embodiments, the association standard may be mitigated, unlike the similarity standard. That is, when the association standard is lower than the similarity standard, it is determined that there is an association and other web pages in an associated web page group will be recommended only if the user 10 reads some web pages included in the multi-concept network. Several web page groups may also be recommended.

Meanwhile, in order to obtain the association, the web pages read by the user 10 must be those that have been preprocessed and selected. That is, meaningless web pages read by the user 10 must be excluded, as in the preprocessing step of the above method for building a multi-concept network.

In step (i), when it is determined in step (h) that there is an association, web pages belonging to the web page node group are recommended to the user (S80). In this case, highly weighted web pages may be preferentially recommended.

For example, in FIG. 8, if the user has read web pages 3 and 6 using the keyword “soccer,” web page 10 or 7 may be recommended to the user.

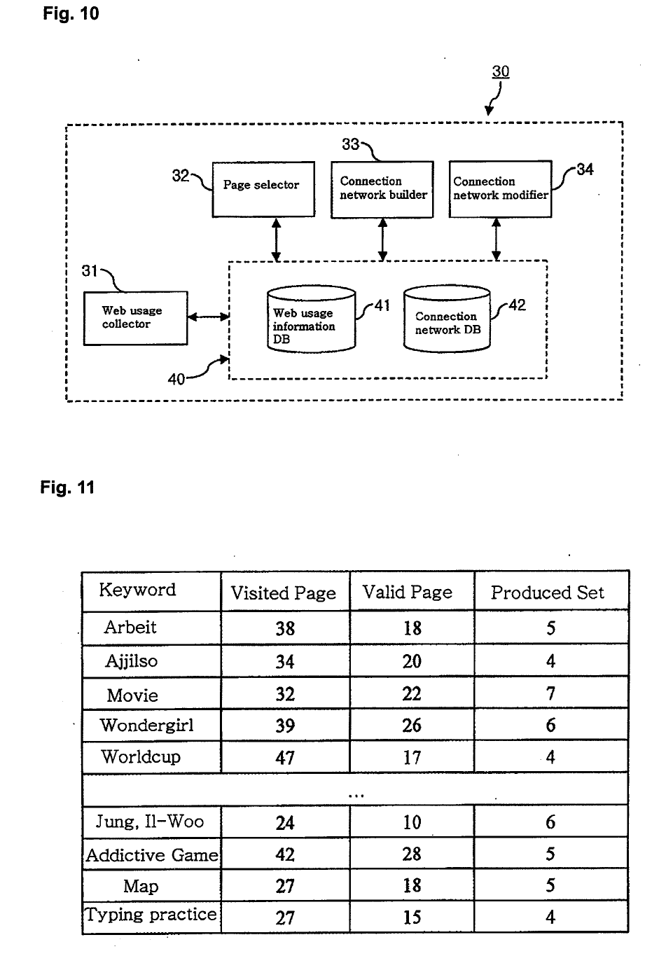

A system 30 for building a multi-concept network based on web usage data according to an exemplary embodiment of the present invention will now be described with reference to FIG. 10. FIG. 10 is a block diagram of a system for building a multi-concept network based on web usage data according to an exemplary embodiment of the present invention.

Referring to FIG. 10, a system 30 for building a multi-concept network includes a web usage collector 31, a page selector 32, a connection network builder 33, and a connection network modifier 34.

The web usage collector 31 collects keywords input by a user for searches in a site and information on web pages read according to keyword search results. In particular, the web page information collected by the web usage collector 31 includes URLs of web pages. The collected web page information is web page evaluation factors, which include at least one of web page use start time and end time, download rate, edit command use rate, addition to Favorites rate, and web page contents size.

The page selector 32 selects read web pages for each user for each keyword. The page selector 32 selects the web pages using a value obtained by weighting evaluation factors of the web page information and summing the weighted factors. Also, the page selector 32 selects only web pages having a PageWeight value, which is obtained by Expression 1 using the evaluation factors Attributeᵢ (i=1, 2, . . . , n) of the web page information, that is above a predetermined standard value.

The connection network builder 33 sets each selected web page as one node for each keyword, groups the web page nodes for each user, connects the web page nodes in a row, and arranges the groups around the keyword. In particular, the connection network builder 33 more closely connects a first read web page to the keyword. When one group includes overlapping (or the same) web pages, the connection network builder 33 integrates the overlapping web pages into the first read web page.

The connection network modifier 34 obtains a similarity between groups of web page nodes arranged around the keyword, and integrates the groups to form a group connected in a row when the similarity is above a predetermined standard value. In particular, the connection network modifier 34 obtains the similarity between two the groups by multiplying the number of overlapping web pages and the number of non-overlapping web pages by weights.

A system for recommending a web page using a multi-concept network according to an exemplary embodiment of the present invention will now be described with reference to FIG. 11. FIG. 11 is a block diagram of a system for recommending a web page using a multi-concept network according to an exemplary embodiment of the present invention.

Referring to FIG. 11, a system 50 for recommending a web page includes a connection network storage unit 51, a web usage capturing unit 52, an association determiner 53, and a page recommender 54 in order to recommend a related keyword through the built multi-concept network.

The connection network storage unit 51 stores the multi-concept network consisting of a plurality of keywords and web page nodes grouped and arranged with respect the keyword, which is built by the connection network modifier.

The web usage capturing unit 52 captures a keyword input by a user in a search site, and information on web pages read according to keyword search results.

The association determiner 53 determines whether there is an association between the web pages read using the keyword and the groups of web page nodes arranged around the same keyword in the multi-concept network. In particular, the association determiner 53 obtains an association degree between the read web pages and the web page node groups by multiplying the number of overlapping web pages and the number of non-overlapping web pages by weights. When the association degree exceeds a predetermined standard value, the association determiner 53 determines that there is an association between the read web pages and the web page node groups.

When the association determiner determines that there is an association, the page recommender 54 recommends web pages belonging to the web page node group to the user.

Meanwhile, the system 50 for recommending a web page uses a database 60 in order to store data. The database 60 may include a web usage data DB 61 or a connection network DB 62 for storing captured web usage information of the user 10, i.e., the keyword and the web page information. The system 50 may separately have the database 60 or may share the database 40 with the system 30 for building a multi-concept network.

Although the system 50 for recommending a web page and the system 30 for building a multi-concept network have been described as separate systems, they may be integrated into a single system. For example, both systems may be disposed in the search site 20 and used in a connected form. The multi-concept network system 30 continuously collects keywords input by users and web page information to continuously update the multi-concept network, and the system 50 for recommending a web page may recommend web pages to the user 10 using the updated data.

For details on the system for building a multi-concept network based on web usage data, refer to the description of the method for building a multi-concept network based on web usage data.

Although an exemplary embodiment in which web pages are recommended using the multi-concept network has been illustrated, the present invention may be applied to other applications. For example, the present invention may be applied to basic technology capable of understanding semantics of words mechanically. When it is assumed that there are two keywords and when multi-concept networks for the two keywords have a similar structure, there may be an association between the two keywords. Accordingly, the two keywords may be connected by semantics.

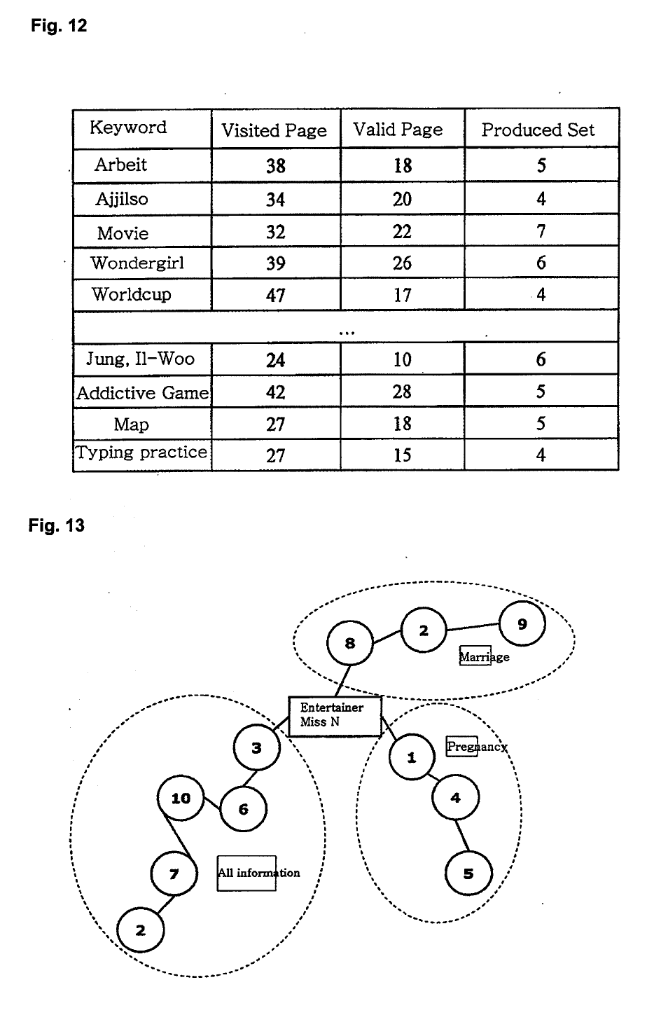

An experiment for building a web usage data-based multi-concept network according to an exemplary embodiment of the present invention will now be described with reference to FIGS. 12 and 13. FIG. 12 illustrates a keyword used for the experiment for building a web usage data-based multi-concept network according to an exemplary embodiment of the present invention, and FIG. 13 illustrates a result of a multi-concept network built according to the experiment in FIG. 12.

As shown in FIG. 12, this experiment selected and used twenty keywords, excluding game and specific sites, from the popular search ranking Top 30 of 2006 and 2007 provided by Google, Yahoo, and Naver search engines. In the case of a keyword for accessing a specific site (such as Lotto, Nation Tax Service, EBS, etc.) or a keyword for playing a game (such as Sudden Attack, Dungeon & Fighter, etc.), a user moves to a desired site through one click on the search result. When there is an absolute site desired by all users for any keyword, recommendation may be meaningless. Seven people were selected as experimental subjects. The collected data shows that a total of 823 web pages were visited, meaningless web pages were eliminated, and 451 web pages were used for building the multi-concept network.

Using the method for building a multi-concept network, 141 groups were integrated into 83 groups. FIG. 13 illustrates a network of a keyword “entertainer Miss N” using the method for building a multi-concept network.

A group including web pages 1, 4, and 5 includes articles about pregnancy and divorce of Miss N, an entertainer, pages 8, 2, and 9 include an article about Miss N before marriage, and pages 3, 6, 10, 7 and 2 include all articles about Miss N.

The method and system for building a multi-concept network according to the present invention build a multi-concept network containing information on a variety of tendencies for a keyword. That is, the multi-concept network can be built for each keyword through user search activity analysis, and the built network can be utilized as basic technology for advertisement, web page recommendation, and keyword meaning analysis.

The present invention can be applied to technology for grouping and producing webs pages containing information on a variety of tendencies for a keyword. In particular, web pages are grouped for each keyword through user search activity analysis to build a multi-concept network, which can be utilized as basic technology for advertisement, web page recommendation, and keyword meaning analysis.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for building a multi-concept network based on web usage data that collects keywords used in a search site utilized by a plurality of users and web page information and builds the multi-concept network for a specific keyword, the method comprising:
(a) collecting the keywords input by the users for searches in the site and the information on web pages read according to keyword search results;
(b) for each keyword, selecting read web pages for each user;
(c) for each keyword, setting each selected web page as one node, grouping the web page nodes for each user, connecting the web page nodes in a row, and arranging the web page nodes around the keyword; and
(d) obtaining a similarity between two groups of the web page nodes arranged around the keyword, and integrating the two groups to form one group connected in a row when the similarity is above a predetermined standard value.

2. The method of claim 1, wherein in step (a), the collected web page information comprises web page URLs, and
the collected web page information comprises, as web page evaluation factors, at least one of web page use start time and end time, download rate, edit command use rate, addition to Favorites rate, and web page contents size.

3. The method of claim 2, wherein step (b) comprises: obtaining a weight of web page by weighting evaluation factors of the web page information and summing the weighted factors, and selecting a web page only if its weight meets a predetermined standard.

4. The method of claim 3, wherein step (b) comprises: setting a PageWeight value as the web page weight, the PageWeight value being obtained by Expression 1 using evaluation factors Attributeᵢ (i=1, 2, . . . , n) of the web page information, and selecting only web pages whose weight exceeds a predetermined standard value:
$${PageWeight}_{j} = 1 - ( \frac{1}{{\sum }_{i = 0}^{n} ( {C}_{i} \cdot {Attribute}_{i} )} ) \qquad Expression 1$$

5. The method of claim 3, wherein step (c) comprises: when the group includes overlapping web pages, integrating the overlapping web pages into a first read web page.

6. The method of claim 5, wherein step (d) comprises: when the two groups are integrated into one group, integrating overlapping web pages between the two groups into a first read web page.

7. The method of claim 6, wherein when the web pages are integrated, the weight of the resulting web page is determined as the sum of the weights of the integrated web pages.

8. The method of claim 1, wherein step (d) comprises: obtaining the similarity between the two groups by multiplying the number of overlapping web pages and the number of non-overlapping web pages by weights.

9. The method of claim 8, wherein step (d) comprises obtaining the similarity between the two groups using Equation 2:
Sim(X,Y)=ω_{S}S×ωᵤU Expression 2
where S denotes the number of web pages included in both of the two groups, U denotes the number of web pages not included in both of the two groups, Ws denotes weights of the web pages included in both of the two groups, and Wu denotes weights of the web pages not included in both of the two groups.

10. A system for building a multi-concept network based on web usage data that collects keywords used in a search site utilized by a plurality of users and web page information and builds the multi-concept network for a specific keyword, the system comprising:
a web usage collector for collecting the keywords input by the users for searches in the site and the information on web pages read according to keyword search results;
a page selector for, for each keyword, selecting read web pages for each user;
a connection network builder for, for each keyword, setting each selected web page as one node, grouping the web page nodes for each user, connecting the web page nodes in a row, and arranging the web page nodes around the keyword; and
a connection network modifier for obtaining a similarity between groups of the web page nodes arranged around the keyword, and integrating the two groups to form one group connected in a row when the similarity is above a predetermined standard value.

11. The system of claim 10, wherein in the web usage collector, the collected web page information comprises web page URLs, and
the collected web page information comprises, as web page evaluation factors, at least one of web page use start time and end time, download rate, edit command use rate, addition to Favorites rate, and web page contents size.

12. The system of claim 11, wherein the page selector obtains a web page weight using a value obtained by weighting evaluation factors of the web page information and summing the weighted factors, and selects the web page only if the web page weight meets a predetermined standard.

13. The system of claim 12, wherein the page selector sets a PageWeight value as the web page weight, the PageWeight value being obtained by Expression 3 using evaluation factors Attribute; (i=1, 2, . . . , n) of the web page information, and selects only web pages whose weight exceeds a predetermined standard value:
$${PageWeight}_{j} = 1 - ( \frac{1}{{\sum }_{i = 0}^{n} ( {C}_{i} \cdot {Attribute}_{i} )} ) \qquad Expression 3$$

14. The system of claim 12, wherein when the group includes overlapping web pages, the connection network builder integrates the overlapping web pages into a first read web page.

15. The system of claim 14, wherein when the two groups are integrated into one group, the connection network modifier integrates overlapping web pages between the two groups into a first read web page.

16. The system of claim 15, wherein when the web pages are integrated, the weight of the resulting web page is determined as the sum of the weights of the integrated web pages.

17. The system of claim 10, wherein the connection network modifier obtains the similarity between the two groups by multiplying the number of overlapping web pages and the number of non-overlapping web pages by weights.

18. The system of claim 17, wherein the connection network modifier obtains the similarity between the two groups using Expression 4.
Sim(X,Y)=ω_{S}S×ωᵤU Expression 4
where S denotes the number of web pages included in both of the two groups, U denotes the number of web pages not included in both of the two groups, Ws denotes weights of the web pages included in both of the two groups, and Wu denotes weights of the web pages not included in both of the two groups.

19. A computer-readable recording medium having a method recorded thereon for building a multi-concept network based on web usage data according to claim 1.

20. A method for recommending a web page to a user who searches for a web page in a search site, using a multi-concept network built by the method of claim 1, the method comprising:
(e) receiving and storing the multi-concept network consisting of a plurality of keywords and web page nodes grouped and arranged around the keywords;
(f) capturing a keyword input by the user in the search site and information on web pages read according to keyword search results;
(g) selecting the web pages read using the keyword;
(h) determining whether there is an association between the selected web pages and groups of web page nodes arranged around the same keyword in the multi-concept network; and
(i) when it is determined in step (h) that there is an association, recommending web pages belonging to the web page node group to the user.

21. The method of claim 20, wherein step (g) comprises: obtaining a weight of a web page by weighting evaluation factors of the web page information and summing the weighted factors, and selecting a web page only if its weight meets a predetermined standard.

22. The method of claim 20, wherein step (h) comprises:
obtaining an association degree between the read web pages and the web page node groups by multiplying the number of overlapping web pages and the number of non-overlapping web pages by weights; and
determining that there is an association between the read web pages and the web page node groups when the association degree exceeds a predetermined standard value.

23. A system for recommending a web page to a user who searches for a web page in a search site, using a multi-concept network built by the system of claim 10, the system comprising:
a connection network storage unit for receiving and storing a multi-concept network consisting of a plurality of keywords and web page nodes grouped and arranged around the keywords;
a web usage capturing unit for capturing a keyword input by the user in the search site and information on web pages read according to keyword search results;
an association determiner for determining whether there is an association between the web pages read using the keyword and groups of web page nodes arranged around the same keyword in the multi-concept network; and
a page recommender for recommending web pages belonging to the web page node group to the user when it is determined by the association determiner that there is an association.

24. The method of claim 23, wherein the association determiner obtains an association degree between the read web pages and the web page node groups by multiplying the number of overlapping web pages and the number of non-overlapping web pages by weights, and determines that there is an association between the read web pages and the web page node groups when the association degree exceeds a predetermined standard value.
